(19) United States
(12) Patent Application Publication
(10) Pub. No.: US 2023/0291311 A1
(43) Pub. Date: Sep. 14, 2023

(54) Observer Based Voltage Regulation Circuitry

(71) Applicant: Arm Limited, Cambridge (GB)

(72) Inventors: Benoit Labbe, Cambridge (GB); Shidhartha Das, Upper Cambourne (GB); Chi-Hsiang Huang, Seattle, WA (US)

(21) Appl. No.: 17/690,343

(22) Filed: Mar. 9, 2022

(51) Int. Cl. H02M 3/157; H02M 3/158

(52) U.S. Cl. CPC H02M 3/157; H02M 3/158

(57) ABSTRACT

Various implementations described herein are related to a device having a power stage that provides an output signal and a first feedback signal based on an input signal and a control signal. The device may have a digital stage with digital circuitry that provides a second feedback signal based on operational activity of the digital circuitry using the output signal. The device may have a control stage that provides the control signal based on the input signal, the first feedback signal and the second feedback signal.

### BACKGROUND

This section is intended to provide information relevant to understanding various technologies described herein. As the section's title implies, this is a discussion of related art that should in no way imply that it is prior art. Generally, related art may or may not be considered prior art. It should therefore be understood that any statement in this section should be read in this light, and not as any admission of prior art.

In modern circuit designs, performance of digital circuitry is typically dependent on supply voltage, process variation and/or temperature. Powering a high-performance digital circuit typically demands a dedicated power-management circuit that is capable of generating needed supply voltage despite changing line and load conditions. Thus, good load transient performances are also needed for voltage regulators to maintain the supply voltage of the digital circuit as constant as possible under fast and large transient loading during operation. In general, central processing units (CPUs), graphics processing units (GPUs), and accelerators are typically known for being challenging loads for their power supplies. Conventional power-converters rely on high-bandwidth, high-gain, closed loop control circuits to keep output impedance of the converter to a minimum, which may allow for minimal transient droop in operation leading to a reduced voltage margin of the digital circuit yielding better energy efficiency of the overall digital system. However, even with the improvements in some modern voltage regulator designs, powering high-performance digital circuitry is inefficient and highly complex for most operational applications. As such, there exists a need to improve voltage regulation in modern circuit designs.

### BRIEF DESCRIPTION OF THE DRAWINGS

Implementations of various techniques are described herein with reference to the accompanying drawings. It should be understood, however, that the accompanying drawings illustrate only various implementations described herein and are not meant to limit embodiments of various techniques described herein.

FIG. 1 illustrates a diagram of observer based voltage regulation circuitry in accordance with implementations described herein.

FIG. 2 illustrates a diagram of observer based voltage regulation circuitry in accordance with implementations described herein.

FIG. 3 illustrates a diagram of observer based voltage regulation circuitry in accordance with implementations described herein.

### DETAILED DESCRIPTION

Various implementations described herein are directed to control loop circuitry for implementing observer based voltage regulation schemes and techniques in physical designs. For instance, various implementations described herein implement an observer path in the control loop of a power supply for a central processing unit (CPU) that uses a feedback signal provided by an activity predictor associated with the CPU. The transient performances of voltage regulators are substantially improved with a significant reduction in transient droop of the load. In various scenarios, digital processors, central processing units (CPUs), graphics processing units (GPUs), or similar typically need dedicated power supply structures. With predictive knowledge of operational activity of digital processors, CPU, GPUs, and the like, various implementations described herein use the activity factor as a feedback signal that predicts a few cycles ahead of time of what the activity factor of the CPU may be in real time. This activity factor information is then used by a voltage regulator to supply the circuit, which allows for a reduction in voltage margin, leading to higher operating frequencies of the CPU or lower operating power.

Various implementations described herein use the CPU activity factor predictor for improving transient performances of the voltage regulator that supplies the CPU. As described in greater detail herein, the activity predictor is output and fed back to the control circuitry of the power converter, and the control circuitry is able to use the reference input along with regulated output voltage, input voltage and the activity predictor to supply the digital circuitry (e.g., CPU, GPU, or similar) with a regulated voltage supply.

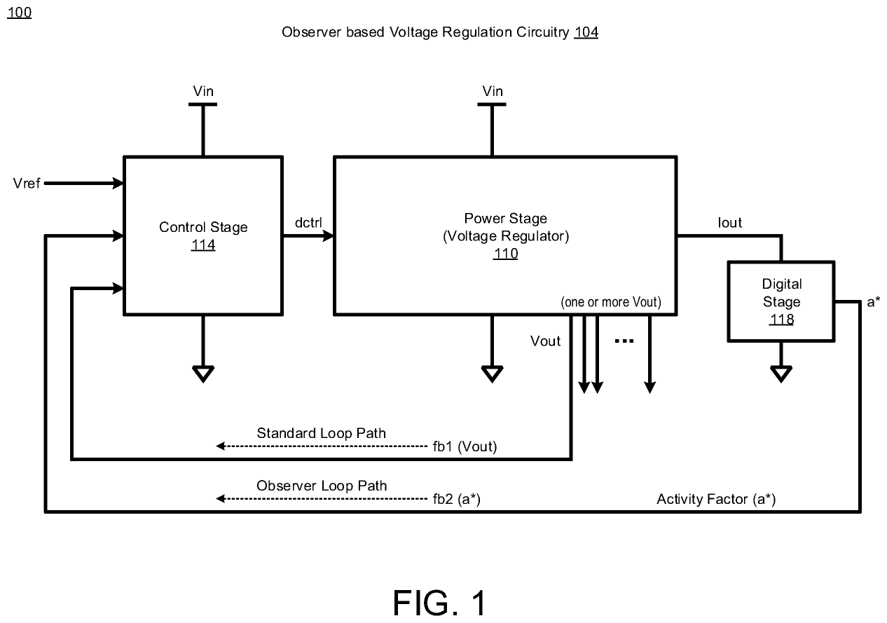

Various implementations of voltage regulation schemes and techniques will be described in greater detail herein with reference to FIGS. 1-3.

FIG. 1 illustrates a diagram 100 of observer based voltage regulation circuitry 104 in accordance with various implementations described herein.

In various implementations, the voltage regulation circuitry 104 may refer to a system or device having various integrated circuit (IC) components that are arranged and coupled together as an assemblage or some combination of parts that provide for physical circuit design and related structures. In some instances, a method of designing, providing and building voltage regulation circuitry 104 as an integrated system or device that may be implemented with various IC circuit components is described herein so as to thereby implement various neural networking schemes and techniques associated therewith. The voltage regulation circuitry 104 may be integrated with various observer based computing circuitry and related components on a single chip, and the voltage regulation circuitry 104 may be implemented in various embedded systems for automotive, electronic, mobile and Internet-of-things (IoT) applications, including remote sensor nodes.

As shown in FIG. 1, the observer based voltage regulation circuitry 104 may be a device having multiple stages, including, e.g., a power stage 110, a control stage 114 and a digital stage 118. The power stage 110 may be coupled between the control stage 114 and the digital stage 118. The control stage 114 and the power stage 110 may be coupled between an input voltage signal (Vin) and ground (Vss, Gnd), and the digital stage 118 may be coupled between an output signal (e.g., output current Iout) and ground (Vss, Gnd). The control stage 114 may receive multiple signals, such as, e.g., the input voltage signal (Vin), a reference voltage signal (Vref), a first feedback signal (fb1, Vout), and a second feedback signal (fb2, a*). The control stage 114 may generate and provide a control signal (dctrl) to the power stage 110 based on one or more of the input signals (Vin, Vref, fb1, fb2). The power stage 110 may include voltage regulator circuitry that is configured to receive the control signal (dctrl) from the control stage 114 and then provide the output signal (Iout) and the first feedback signal (fb1, Vout) based on the control signal (dctrl). The digital stage 118 may include digital circuitry that is configured to receive the output signal (Iout) from the power stage 110 and then provide the second feedback signal (fb2, a*) to the control stage 114.

In some implementations, the power stage 110 may be configured to generate and provide the output signal (Iout) and the first feedback signal (Vout, fb1) based on the input voltage signal (Vin) and the control signal (dctrl). The digital stage 118 may include the digital circuitry 118 that is configured to provide the second feedback signal (fb2, a*) based on operational activity of the digital circuitry 118 using the output signal (Iout). Also, the control stage 114 may be configured to provide the control signal (dctrl) based on the input voltage signal (Vin), the first feedback signal (fb1, Vout), and the second feedback signal (fb2, a*). The first feedback signal (fb1, Vout) may refer to an output power based voltage signal generated and provided by the power stage 110 directly to the control stage 114. The output signal (Iout) may refer to an output power based current signal generated and provided by the power stage 110 directly to the digital circuitry of the digital stage 118. The second feedback signal (fb2, a*) may refer to an activity factor based control voltage signal generated and provided by the digital stage 118 based on the operational activity of the digital circuitry using the output signal (Iout). Also, the activity factor based control voltage signal has an activity factor (*a) that predictively measures the operational activity of the digital circuitry so as to provide an estimation of a number of toggles that are associated with the operational activity of the digital circuitry.

In some implementations, the control stage 114 may be configured to receive the reference signal (Vref) and provide the control signal (dctrl) to the power stage 110 based on the input signal (Vin), the reference signal Vref), the first feedback signal (fb1, Vout) and the second feedback signal (fb2, a*). The control stage 114 may be directly coupled to the power stage 110 so as to provide the control signal (dctrl) to the power stage 110. The input signal (Vin) may refer to an input voltage signal, and the reference signal (Vref) may refer to a reference voltage signal.

In some implementations, the power stage 110 may be configured to operate as a voltage regulator that provides one or more or multiple regulated output signals as output including the first feedback signal (fb1, Vout). The control stage 114 may include signal merging circuitry that receives the first feedback signal (fb1, Vout) from the power stage 110, receives the second feedback signal (fb2, a*) from the digital stage 118, and then merges the first feedback signal (fb1, Vout) and the second feedback signal (fb2, a*) so as to generate and provide the control signal (dctrl) directly to the power stage 110.

In some implementations, the power stage 110 may include voltage regulation circuitry that receives the control signal (dctrl) from the control stage 114 and provides the first feedback signal (fb1, Vout) to the control stage 114 by way of a first feedback loop path (or standard loop path). The power stage 110 may be coupled between the control stage 110 and the digital stage 118 so that the voltage regulation circuitry receives the control signal (dctrl) directly from the control stage 114 and then provides the output signal (Iout) directly to the digital circuitry in the digital stage 118. Thus, the first feedback loop path may be referred to as a standard loop path that is configured to provide the first feedback signal (fb1, Vout) directly to the control stage 114 as an output power based voltage signal generated and provided by the power stage 110.

In some implementations, the digital stage 118 may include the digital circuitry that receives the output signal (Iout) from the power stage 110 and provides the second feedback signal (fb2, a*) to the control stage 110 by way of a second feedback loop path (or observer loop path). Also, the digital stage 118 may be coupled to the power stage 110 and the control stage 114 so that the digital circuitry receives the output signal (Iout) directly from the power stage 110 and then provides the second feedback signal (fb2, a*) directly to the control circuitry 114. Thus, the second feedback loop path may be referred to as an observer loop path that is configured to provide the second feedback signal (fb2, a*) directly to the control stage 114 as an activity factor based signal generated and then provided by the digital stage 118 based on the operational activity of the digital circuitry using the output signal (Iout).

In various implementations, the digital circuitry in the digital stage 118 may refer to various types of digital processing logic, components and/or circuitry with at least one of a processor, a central processing unit (CPU), a digital signal processor (DSP), and a graphics processing unit (GPU). Various other similar types of digital processing circuits may be used without departing from the scope of the present disclosure.

Advantageously, in some applications, the observer based voltage regulation circuitry 104 is configured to use the activity factor predictor signal (a*) for improving the transient performances of the voltage regulator 110 supplying digital circuitry, such as, e.g., CPU, GPU, or similar. The predictor output (a*) may be fed back to the control stage 114 of the power converter 110 as shown in FIG. 1. As such, the control stage 114 may then use multiple signals, such as, e.g., the reference input (Vref) and other environment measurements: output voltage (Vout) to regulate, the input voltage (Vin), and the activity predictor output (a*) to regulate the voltage supplied to the digital stage 118.

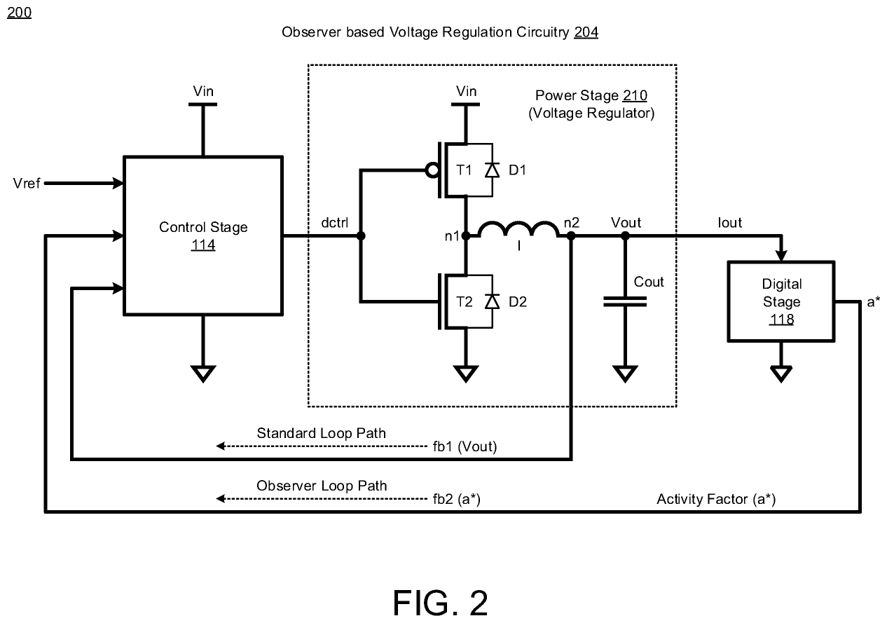

FIG. 2 illustrates a diagram 200 of observer based voltage regulation circuitry 204 in accordance with various implementations described herein. The observer based voltage regulation circuitry 204 in FIG. 2 may have similar features and components in reference to the observer based voltage regulation circuitry 104 in FIG. 1.

In various implementations, the voltage regulation circuitry 204 may refer to a system or device having various integrated circuit (IC) components that are arranged and coupled together as an assemblage or some combination of parts that provide for physical circuit design and related structures. In some instances, a method of designing, providing and building voltage regulation circuitry 204 as an integrated system or device that may be implemented with various IC circuit components is described herein so as to thereby implement various neural networking schemes and techniques associated therewith. The voltage regulation circuitry 204 may be integrated with various observer based computing circuitry and related components on a single chip, and the voltage regulation circuitry 204 may be implemented in various embedded systems for automotive, electronic, mobile and Internet-of-things (IoT) applications, including remote sensor nodes.

As shown in FIG. 2, the observer based voltage regulation circuitry 204 may be a device having multiple stages, including, e.g., a power stage 210, the control stage 114 and the digital stage 118. The power stage 210 may be implemented as a voltage regulator that receives the control signal (dctrl) from the control stage 110 and adjusts the output voltage (Vout). The voltage regulator 210 may be coupled to a load, such as, e.g., the digital circuitry in the digital stage 118, so as to provide and regulate a supply voltage (Vdd) to the digital circuitry, and the voltage regulator 210 may refer to a DC-to-DC voltage converter or buck converter. The voltage regulator 210 may have power transistors (T1, T2) coupled in series between the input signal (Vin) and ground (or Vss). Also, the voltage regulator 210 may have a first diode (D1) coupled in parallel with the first power transistor (T1), and the voltage regulator 210 may have a second diode (D2) coupled in parallel with the second power transistor (T2). The voltage regulator 210 may also include a power coil, such as, e.g., an inductor (I), that is coupled between the power transistors (T1, T2) at node (n1) and the digital stage 118 at node (n2). The voltage regulator 210 may include a charge storage device, such as, e.g., an output capacitor (Cout), that is coupled between the node (n2) and ground (or Vss). Also, in some instances, the digital stage 118 may be coupled between the node (n2) and ground (or Vss), and the digital stage 118 may receive the output voltage (Vout) or output current (Iout) via the node (n2).

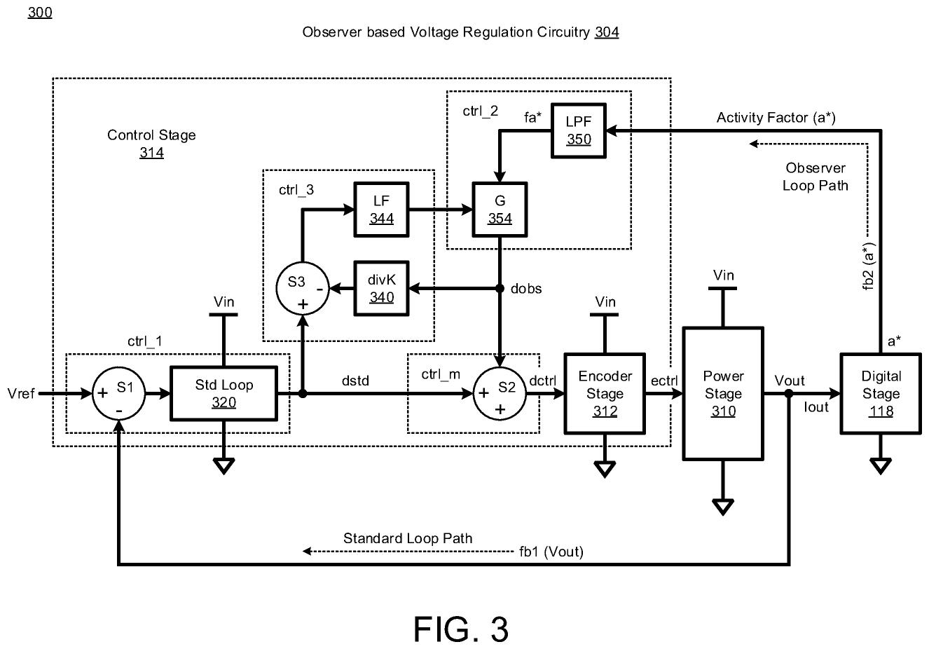

FIG. 3 illustrates a diagram 300 of observer based voltage regulation circuitry 304 in accordance with implementations described herein. The observer based voltage regulation circuitry 304 in FIG. 3 may have similar features and components in reference to the observer based voltage regulation circuitry 104, 204 in FIGS. 1-2.

In various implementations, the voltage regulation circuitry 304 may refer to a system or device having various integrated circuit (IC) components that are arranged and coupled together as an assemblage or some combination of parts that provide for physical circuit design and related structures. In some instances, a method of designing, providing and building voltage regulation circuitry 304 as an integrated system or device that may be implemented with various IC circuit components is described herein so as to thereby implement various neural networking schemes and techniques associated therewith. The voltage regulation circuitry 304 may be integrated with various observer based computing circuitry and related components on a single chip, and the voltage regulation circuitry 304 may be implemented in various embedded systems for automotive, electronic, mobile and Internet-of-things (IoT) applications, including remote sensor nodes.

As shown in FIG. 3, the observer based voltage regulation circuitry 304 may be a device having multiple stages, including, e.g., a power stage 310, a control stage 314 and the digital stage 118. The power stage 310 may have voltage regulation circuitry, the digital stage may have digital circuitry, and the control stage 314 may have first control circuitry (ctrl_1), second control circuitry (ctrl_2), third control circuitry (ctrl_3) and merging circuitry (ctrl_m).

The first control circuitry (ctrl_1) may receive the first feedback signal (fb1, Vout) from the voltage regulation circuitry of the power stage 310, receive the reference voltage signal (Vref) from an external source supply, and provide a first control signal (dstd) based on the first feedback signal (fb1, Vout) and the reference voltage signal (Vref). The first control circuitry (ctrl_1) may include comparator circuitry (S1) and standard loop circuitry 320 coupled together. The standard loop circuitry 320 may be coupled between the input voltage signal (Vin) and ground (or Vss). Also, the comparator circuitry (S1) may receive the first feedback signal (fb1, Vout), receive the first feedback signal (fb1, Vout), and then provide a comparison signal to the standard loop circuitry 320. The standard loop circuitry 320 may receive the comparison signal from the standard loop circuitry 320, receive the input voltage signal (Vin), and then provide the first control signal (dstd).

The second control circuitry (ctrl_2) may receive the second feedback signal (fb2, (a*) from the digital circuitry of the digital stage 118 and provide a second control signal (dobs) based on the second feedback signal (fb2, a*). The second control circuitry (ctrl_2) may include first filter circuitry (LPF) 350 and gain circuitry (G) 354. The first filter circuitry (LPF) 350 may operate as a low pass filter (LPF). The first filter circuitry (LPF) 350 may receive the second feedback signal (fb2, a*) from the digital circuitry of the digital stage 118 and provide a filtered second feedback signal (fa*) to the gain circuitry (G) 354. Also, the gain circuitry (G) 354 may generate and provide the second control signal (dobs) to the merging circuitry (ctrl_m) based on the filtered second feedback signal (fa*).

The merging circuitry (ctrl_m) may receive the first control signal (dstd) from the first control circuitry (ctrl_1), receive the second control signal (dobs) from the second control circuitry (ctrl_2), and then generate and provide the output control signal (dctrl) to the voltage regulation circuitry of the power stage 310 (via an encoder stage 312) based on the first control signal (dobs) and the second control signal (dobs). In some instances, the merging circuitry (ctrl_m) provides the output control signal (dctrl) to encoder circuitry of the encoder stage 312, and the encoder circuitry generates and provides an encoded output control signal (ectrl) to the voltage regulation circuitry of the power stage 310.

In various implementations, the voltage regulation circuitry of the power stage 310 provides one or more or multiple regulated output signals (Vout) as output including the first feedback signal (fb1). The first control circuitry (ctrl_1) receives the input voltage (Vin), receives the reference voltage (Vref), receives the first feedback signal (fb1, Vout) from the voltage regulation circuitry of the power stage 310, and provides the first control signal (dstd) to the merging circuitry (ctrl_m) of the control stage 314 based on the input voltage (Vin), the reference voltage (Vref) and the first feedback signal (fb1, Vout). The merging circuitry (ctrl_m) may have summation circuitry (S2) that is configured to receive the first control signal (dstd), receive the second control signal (dobs), and add or sum the first and second control signals (dstd, dobs) together so as to generate and then provide the output control signal (dctrl).

In various implementations, the first feedback signal (fb1, Vout) may refer to an output power based voltage signal generated and provided by voltage regulation circuitry of the power stage 310 directly to the first control circuitry (ctrl_1). The second feedback signal (fb2, a*) may refer to an activity factor based signal generated and provided by the digital circuitry based on the operational activity of the digital circuitry. In some instances, the activity factor based signal may have an activity factor that predictively measures the operational activity of the digital circuitry so as to provide an estimation of a number of toggles associated with the operational activity of the digital circuitry.

In some implementations, the encoding circuitry of the encoder stage 312 may receive the output control signal (dctrl) from the merging circuitry (ctrl_m) and provide an encoded output control signal (ectrl) to the voltage regulation circuitry of the power stage 310. The voltage regulation circuitry may receive the encoded output control signal (ectrl) from the encoding circuitry and provide the first feedback signal (fb1, Vout) to the first control circuitry (ctrl_1) by way of the first feedback loop path (or standard loop path). The first feedback loop path may refer to a standard loop path configured to provide the first feedback signal (fb1, Vout) directly to the first control circuitry (ctrl_1) as an output power based voltage signal generated and provided by the voltage regulation circuitry.

In some implementations, the power stage 310 may have the voltage regulation circuitry as directly coupled to the digital circuitry of the digital stage 118. Also, the voltage regulation circuitry may be configured to generate and provide the output power based current signal (Iout) directly to the digital circuitry for operation thereof. Further, the digital circuitry of the digital stage 118 may receive the output power based current signal (Iout) from the voltage regulation circuitry and then provide the second feedback signal (fb2, a*) to the second control circuitry (ctrl_2) by way of a second feedback loop path. The second feedback loop path may refer to an observer loop path that is configured to provide the second feedback signal (fb2, a*) directly to the second control circuitry (ctrl_2) as an activity factor based signal generated and provided by digital circuitry of the digital stage 118 based on the operational activity of the digital circuitry.

In some implementations, the third control circuitry (ctrl_3) may have a second filtering circuitry (LF) 344, signal scaling circuitry (divK) 340 and comparator circuitry (S3). The signal scaling circuitry (divK) 340 may receive the second control signal (dobs) from the gain circuitry (G) 354 and provide a scaled second control signal to the comparator circuitry (S3). Also, the comparator circuitry (S3) may receive the first control signal (dstd) from the first control circuitry (ctrl_1), receive the scaled second control signal from the signal scaling circuitry (divK) 340, and provide a comparator signal to the second filtering circuitry (LF) 344. Also, the second filtering circuitry (LF) 344 may receive the comparator signal from the comparator circuitry (S3) and provide a filtered comparator signal to the gain circuitry (G) 354. Also, the second filtering circuitry (LF) 344 may include linear filter (LF) circuitry. In some instances, the gain circuitry (G) 354 may generate and provide the second control signal (dobs) to the merging circuitry (ctrl_m) based on filtered comparator signal from the LF 344 and the filtered second feedback signal (fa*).

In some implementations, the control stage 314 of the power-converter may be altered to take the observer point-of-view (PoV) into account, as shown in FIG. 3. The standard loop control (ctrl_1) compares the output voltage (fb1, Vout) to the reference voltage (Vref) and processes the voltage error following a control law that is then encoded to drive the power stage 310 (e.g., dstd to dctrl to ectrl). The control law may refer a linear control based method or a modern control based method, such as, e.g., a sliding-mode control method, H-infinity control method, or similar. The encoding may also be achieved under the form of a pulse width modulation or pulse density modulation for switched mode operation or gate voltage or activation ratio for linear mode operation.

The control stage 314 includes second control circuitry (ctrl_2) that receives the signal from the observer (a*), filters it (fa*), and applies a gain correction (G) before adding the result (dobs) to the output of the standard control signal (dstd). The filter (LPF) 350 brings two benefits, wherein LPF 350 filters observer noise, as the prediction is inherently noisy, thus reducing the rate of misprediction. Also, LPF 350 delays the observer signal (a*) to its group delay so as to align the effect of the observer loop and the actual load transient of the digital circuitry in the digital stage 118.

As shown in FIG. 3, the power converter includes the control stage 314 and the observer feedback path (fb2, a*). Equation 1 below outlines that even with an accurate knowledge of the activity factor (a*) and equivalent capacitance of the circuit, the observer output may not be scaled appropriately as the current also depends on the supply voltage and clock frequency. Auto-scaling may be performed in ctrl_3, and gain G in the observer path may provide for integration in ctrl_3 with Equation 1:

dstd−divK×dobs=0 Equation 1:

Thus, the ratio between the contribution of the observer path and the feedback path may be simply expressed as:

dstd−dobs=divK Equation 2:

Accordingly, in various implementations, the multi-path control loop circuitry for the standard loop path and the observer loop path provides for observer based voltage regulation schemes and techniques in physical circuit designs. For instance, the observer path in the control loop of the power supply for the digital stage 118 uses the feedback signal (fb2, a*) provided by the activity predictor associated with the digital circuitry, such as, e.g., CPU. GPU, or similar. The transient performance of the voltage regulator in the power stage 310 is substantially improved with significant reduction in transient droop of the digital stage 118. As described herein, use of the activity factor (a*) may provide for predictive knowledge of operational activity of the digital circuitry in the digital stage 118, such that the activity factor (a*) is used as the second feedback signal (fb2) that predicts a few cycles ahead of time of what the activity factor of the CPU may be in real time. This activity factor (a*) is then used with substantial effect by the voltage regulator in the power stage 310 to supply the digital circuitry, which allows for a reduction in voltage margin, leading to higher operating frequencies of the CPU or lower operating power.

Various implementations described herein use the CPU activity factor predictor (a*) for improving transient performances of the voltage regulation circuitry in the power stage 310 that supplies the digital circuitry in the digital stage 118. As described herein, the activity predictor (a*) is output and fed back to the control circuitry of the control stage 314, and the control circuitry is able to use the reference input (Vref) along with regulated output voltage (fb1, Vout), input voltage (Vin) and the activity predictor (fb2, a*) to supply the digital circuitry (e.g., CPU) with the regulated voltage supply (Vout, Iout).

Implementations of various technologies described herein may be operational with numerous general purpose or special purpose computing system environments or configurations. Examples of computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, marine electronics devices, and the like.

Described herein are various implementations of a device with a power stage that provides an output signal and a first feedback signal based on an input signal and a control signal. The device may have a digital stage with digital circuitry that provides a second feedback signal based on operational activity of the digital circuitry using the output signal. The device may have a control stage that provides the control signal based on the input signal, the first feedback signal and the second feedback signal.

Described herein are various implementations of a device having first control circuitry that receives a first feedback signal from voltage regulation circuitry and provides a first control signal based on the first feedback signal. The device may have second control circuitry that receives a second feedback signal from digital circuitry and provides a second control signal based on the second feedback signal. The device may have merging circuitry that receives the first control signal from the first control circuitry, receives the second control signal from the second control circuitry, and then generates and provides an output control signal to the voltage regulation circuitry based on the first control signal and the second control signal.

The various technologies described herein may be implemented in the general context of computer-executable instructions, such as program modules, being executed by a computer. Program modules include routines, programs, objects, components, data structures, etc. that perform particular tasks or implement particular abstract data types. Further, each program module may be implemented in its own way, and all need not be implemented the same way. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or some combination of both.

The various technologies described herein may be implemented in distributed computing environments where tasks are performed by remote processing devices that are linked through a communications network, e.g., by hardwired links, wireless links, or various combinations thereof. In a distributed computing environment, program modules may be located in both local and remote computer storage media including, for example, memory storage devices and similar.

Further, the discussion provided herein may be considered directed to certain specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the following detailed description, numerous specific details are set forth to provide a thorough understanding of the disclosure provided herein. However, the disclosure provided herein may be practiced without these specific details. In some other instances, well-known methods, procedures, components, circuits and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A device comprising:
a power stage that provides an output signal and a first feedback signal based on an input signal and a control signal;
a digital stage having digital circuitry that provides a second feedback signal based on operational activity of the digital circuitry using the output signal; and
a control stage that provides the control signal based on the input signal, the first feedback signal and the second feedback signal.

2. The device of claim 1, wherein:
the first feedback signal refers to an output power based voltage signal generated and provided by the power stage directly to the control stage, and
the output signal refers to an output power based current signal generated and provided by the power stage directly to the digital circuitry of the digital stage.

3. The device of claim 1, wherein:
the second feedback signal refers to an activity factor based control voltage signal generated and provided by the digital stage based on the operational activity of the digital circuitry using the output signal.

4. The device of claim 3, wherein:
the activity factor based control voltage signal has an activity factor that predictively measures the operational activity of the digital circuitry so as to provide an estimation of a number of toggles associated with the operational activity of the digital circuitry.

5. The device of claim 1, wherein:
the control stage receives a reference signal and provides the control signal to the power stage based on the input signal, the reference signal, the first feedback signal and the second feedback signal,
the control stage is directly coupled to the power stage so as to provide the control signal to the power stage, and
the input signal refers to an input voltage signal, and the reference signal refers to a reference voltage signal.

6. The device of claim 1, wherein:
the power stage provides multiple regulated output signals as output including the first feedback signal, and
the control stage includes signal merging circuitry that receives the first feedback signal from the power stage, receives the second feedback signal from the digital stage and then merges the first feedback signal and the second feedback signal so as to thereby generate and provide the control signal directly to the power stage.

7. The device of claim 1, wherein:
the power stage includes voltage regulation circuitry that receives the control signal from the control stage and then provides the first feedback signal to the control stage by way of a first feedback loop path, and
the power stage is coupled between the control stage and the digital stage so that the voltage regulation circuitry receives the control signal directly from the control stage and then provides the output signal directly to the digital circuitry.

8. The device of claim 7, wherein the first feedback loop path is a standard loop path that is configured to provide the first feedback signal directly to the control stage as an output power based voltage signal generated and provided by the power stage.

9. The device of claim 1, wherein:
the digital stage includes the digital circuitry that receives the output signal from the power stage and then provides the second feedback signal to the control stage by way of a second feedback loop path, and
the digital stage is coupled to the power stage and the control stage so that the digital circuitry receives the output signal directly from the power stage and then provides the second feedback signal directly to the control circuitry.

10. The device of claim 9, wherein the second feedback loop path is an observer loop path that is configured to provide the second feedback signal directly to the control stage as an activity factor based signal generated and provided by the digital stage based on the operational activity of the digital circuitry using the output signal.

11. The device of claim 1, wherein the digital circuitry comprises processing circuitry with at least one of a processor, a central processing unit (CPU), a digital signal processor (DSP), and a graphics processing unit (GPU).

12. A device comprising:
first control circuitry that receives a first feedback signal from voltage regulation circuitry and provides a first control signal based on the first feedback signal;
second control circuitry that receives a second feedback signal from digital circuitry and provides a second control signal based on the second feedback signal; and
merging circuitry that receives the first control signal from the first control circuitry, receives the second control signal from the second control circuitry, and then generates and provides an output control signal to the voltage regulation circuitry based on the first control signal and the second control signal.

13. The device of claim 12, wherein:
the voltage regulation circuitry provides multiple regulated output signals as output including the first feedback signal, and
the first control circuitry receives an input voltage, receives a reference voltage, receives the first feedback signal from the voltage regulation circuitry, and provides the first control signal to the merging circuitry based on the input voltage, the reference voltage and the first feedback signal.

14. The device of claim 12, wherein:
the first feedback signal refers to an output power based voltage signal generated and provided by the voltage regulation circuitry directly to the first control circuitry, and
the second feedback signal refers to an activity factor based signal generated and provided by the digital circuitry based on the operational activity of the digital circuitry.

15. The device of claim 14, wherein:
the activity factor based signal has an activity factor that predictively measures the operational activity of the digital circuitry so as to provide an estimation of a number of toggles associated with the operational activity of the digital circuitry.

16. The device of claim 12, further comprising:
encoding circuitry that receives the output control signal from the merging circuitry and provides an encoded output control signal to the voltage regulation circuitry,
the voltage regulation circuitry receives the encoded output control signal from the encoding circuitry and then provides the first feedback signal to the first control circuitry by way of a first feedback loop path, and
the first feedback loop path refers to a standard loop path that is configured to provide the first feedback signal directly to the first control circuitry as an output power based voltage signal generated and provided by the voltage regulation circuitry.

17. The device of claim 12, wherein:
the voltage regulation circuitry is directly coupled to the digital circuitry,
the voltage regulation circuitry is configured to generate and provide an output power based current signal directly to the digital circuitry for operation thereof, and
the digital circuitry receives the output power based current signal from the voltage regulation circuitry and then provides the second feedback signal to the second control circuitry by way of a second feedback loop path.

18. The device of claim 17, wherein the second feedback loop path is an observer loop path that is configured to provide the second feedback signal directly to the second control circuitry as an activity factor based signal generated and provided by the digital circuitry based on the operational activity of the digital circuitry.

19. The device of claim 12, wherein:
the second control circuitry includes first filter circuitry and gain circuitry,
the first filter circuitry receives the second feedback signal from the digital circuitry and provides a filtered second feedback signal to the gain circuitry, and
the gain circuitry generates and provides the second control signal to the merging circuitry based on the filtered second feedback signal.

20. The device of claim 19, further comprising:
third control circuitry having a second filtering circuitry, signal scaling circuitry and comparator circuitry,
wherein the signal scaling circuitry receives the second control signal from the gain circuitry and provides a scaled second control signal to the comparator circuitry,
wherein the comparator circuitry receives the first control signal from the first control circuitry, receives the scaled second control signal from the signal scaling circuitry, and provides a comparator signal to the second filtering circuitry,
wherein the second filtering circuitry receives the comparator signal from the comparator circuitry and provides a filtered comparator signal to the gain circuitry, and
wherein the gain circuitry generates and provides the second control signal to the merging circuitry based on the filtered comparator signal and the filtered second feedback signal.
